(19) United States
(12) Patent Application Publication
(10) Pub. No.: US 2026/0303814 A1
(43) Pub. Date: Oct. 1, 2026

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); Kia Corporation, Seoul (KR)

(72) Inventors: Jungah CHOI, Seoul (KR); Jin HEO, Yongin-si, Gyeonggi-do (KR); Seung Wook PARK, Yongin-si, Gyeonggi-do (KR)

(73) Assignees: HYUNDAI MOTOR COMPANY, Seoul (KR); Kia Corporation, Seoul (KR)

(21) Appl. No.: 19/475,693

(22) PCT Filed: Jun. 7, 2024
(86) PCT No.: PCT/KR2024/007817

§ 371 Date: Oct. 15, 2025

(30) Foreign Application Priority Data
Jun. 8, 2023 (KR) 10-2023-0073463
Jun. 7, 2024 (KR) 10-2024-0074453

(51) Int. Cl. H04N 19/136; H04N 19/176

(52) U.S. Cl. CPC H04N 19/136; H04N 19/176

(57) ABSTRACT

Provided are an image encoding/decoding method and apparatus, a recording medium for storing a bitstream and a transmission method. The image decoding method may comprise generating a first prediction block of a current block based on a first block vector, generating a second prediction block of the current block based on a second block vector and generating a final prediction block of the current block by a weighted sum of the first prediction block and the second prediction block. The first prediction block may be generated based on a first matching block in a current picture indicated by the first block vector, and the second prediction block may be generated based on a second matching block in the current picture indicated by the second block vector.

### TECHNICAL FIELD

The present invention relates to a method and apparatus for encoding/decoding an image and a recording medium storing a bitstream. Specifically, the present invention relates to a method and apparatus for encoding/decoding an image based on an improved intra-block copy (IBC)-based prediction method and a recording medium storing a bitstream.

### BACKGROUND ART

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

In a video coding and decoding method and apparatus, intra block copy (IBC) is a technique for searching for a prediction block for a current coding unit (CU) block (current block) in an already reconstructed area. Intra block copy prediction has high prediction accuracy for screen content with repeated similar shapes. In particular, when there is no reference picture and only intra prediction is applicable, encoding efficiency can be improved by applying intra block copy prediction. Therefore, various tools for intra block copy prediction are being discussed in order to improve encoding efficiency when only intra prediction is applicable.

### DISCLOSURE

### Technical Problem

Various aspects of the present invention is to provide an image encoding/decoding method and apparatus with improved encoding/decoding efficiency.

In addition, various aspects of the present invention is to provide a recording medium for storing a bitstream generated by an image decoding method or apparatus according to the present invention.

In addition, various aspects of the present invention is to provide a prediction method for solving the problems of the existing bi-predictive intra block copy-based prediction as described above.

### Technical Solution

An image decoding method according to an embodiment of the present invention may comprise generating a first prediction block of a current block based on a first block vector, generating a second prediction block of the current block based on a second block vector and generating a final prediction block of the current block by a weighted sum of the first prediction block and the second prediction block. The first prediction block may be generated based on a first matching block in a current picture indicated by the first block vector, and the second prediction block may be generated based on a second matching block in the current picture indicated by the second block vector.

In the image decoding method, the first block vector may be derived by performing block vector prediction, and the second block vector may be determined based on an intra block copy merge candidate list and an index indicating one merge candidate.

In the image decoding method, the first block vector and the second block vector may be determined based on an intra block copy merge candidate list and a first merge index and second merge index indicating different merge candidates.

In the image decoding method, the final prediction block of the current block may be generated by adding the first prediction block to which a first weight is applied and the second prediction block to which a second weight is applied.

In the image decoding method, the first weight and the second weight may be determined to be preset values.

In the image decoding method, the first weight and the second weight may be determined based on an index indicating one weight candidate among a plurality of preset weight candidates.

In the image decoding method, a codeword assigned to each of the plurality of preset weight candidates may be determined based on a usage frequency of each of the plurality of weight candidates.

In the image decoding method, the first weight and the second weight may be determined based on a first index indicating one weight candidate set among a plurality of weight candidate sets and a second index indicating one weight candidate among a plurality of weight candidates included in one weight candidate set.

In the image decoding method, the first index may indicate a weight candidate set used in at least one of a picture group, a slice group or a block group, and the second index may indicate a weight candidate used in at least one unit of a picture, a slice or a block.

In the image decoding method, the at least one unit may be a unit of a lower layer corresponding to the at least one group.

In the image decoding method, the first weight and the second weight may be determined based on a first distortion value, which is a distortion value between a current template adjacent to the current block and a first reference template adjacent to the first matching block, and a second distortion value, which is a distortion value between a current template adjacent to the current block and a second reference template adjacent to the second matching block.

In the image decoding method, the first distortion value and the second distortion value may be measured through any one of a sum of absolute differences (SAD) measurement method or a sum of square error (SSE) measurement method.

In the image decoding method, the first weight and the second weight may be determined based on a look-up table corresponding to the first distortion value and the second distortion value.

In the image decoding method, a shape of the current template may be determined to be one of a first template shape including samples adjacent to the left side of the current block, a second template shape including samples adjacent to the top side of the current block, and a third template shape including samples adjacent to the left side of the current block and samples adjacent to the top side of the current block, and the shapes of the first reference template and the second reference template may correspond to the shape of the current template.

In the image decoding method, the final prediction block of the current block may be generated by a weighted sum of the first prediction block and the second prediction block based on a comparison result between a threshold value, which is derived based on the first distortion value, and the second distortion value.

In the image decoding method, the second distortion value may be a value smaller than the first distortion value, and when the second distortion value is smaller than or equal to the threshold, the final prediction block of the current block may be generated by a weighted sum of the first prediction block and the second prediction block.

In the image decoding method, the second distortion value may be a value greater than the first distortion value, and when the second distortion value is less than the threshold value, the final prediction block of the current block may be generated by a weighted sum of the first prediction block and the second prediction block.

An image encoding method according to an embodiment of the present invention may comprise generating a first prediction block of a current block based on a first block vector, generating a second prediction block of the current block based on a second block vector, and generating a final prediction block of the current block by a weighted sum of the first prediction block and the second prediction block. The first prediction block may be generated based on a first matching block in a current picture indicated by the first block vector, and the second prediction block may be generated based on a second matching block in the current picture indicated by the second block vector.

A non-transitory computer-readable recording medium according to an embodiment of the present invention may store a bitstream generated by an image encoding method. The image encoding method may comprise generating a first prediction block of a current block based on a first block vector, generating a second prediction block of the current block based on a second block vector, and generating a final prediction block of the current block by a weighted sum of the first prediction block and the second prediction block. The first prediction block may be generated based on a first matching block in a current picture indicated by the first block vector, and the second prediction block may be generated based on a second matching block in the current picture indicated by the second block vector.

A transmission method according to an embodiment of the present invention may comprise transmitting a bitstream generated by an image encoding method. The image encoding method may comprise generating a first prediction block of a current block based on a first block vector, generating a second prediction block of the current block based on a second block vector, and generating a final prediction block of the current block by a weighted sum of the first prediction block and the second prediction block. The first prediction block may be generated based on a first matching block in a current picture indicated by the first block vector, and the second prediction block may be generated based on a second matching block in the current picture indicated by the second block vector. The features briefly summarized above with respect to the present disclosure are merely exemplary aspects of the detailed description below of the present disclosure, and do not limit the scope of the present disclosure.

### Advantageous Effects

According to the present invention, it is possible to provide an image encoding/decoding method and apparatus with improved encoding/decoding efficiency.

In addition, according to the present invention, it is possible to provide a bi-predictive intra block copy-based prediction method using a weighted sum.

In addition, according to the present invention, it is possible to provide a method of determining efficiency of a bi-predictive intra block copy-based prediction method based on distortion values of different prediction signals and determining whether to apply the bi-predictive intra block copy-based prediction method based on result of the determination.

It will be appreciated by persons skilled in the art that that the effects that can be achieved through the present invention are not limited to what has been particularly described hereinabove and other advantages of the present invention will be more clearly understood from the detailed description.

### DESCRIPTION OF DRAWINGS

FIG. 1 is a block diagram showing a configuration of an encoding apparatus an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 is a diagram for explaining an intra block copy-based prediction method according to an embodiment of the present invention.

FIG. 5 is a diagram for explaining a bi-predictive intra block copy-based prediction method according to an embodiment of the present invention.

FIG. 6 is a diagram for explaining a bi-predictive intra block copy-based prediction method according to another embodiment of the present invention.

FIG. 7 is a diagram for explaining a plurality of template shape candidates used in a process of deriving distortion values for prediction values according to an embodiment of the present invention.

FIG. 8 is a flowchart illustrating an intra block copy prediction method according to an embodiment of the present invention.

FIG. 9 is a view for illustrating a content streaming system to which an embodiment according to the present invention is applicable.

### MODE FOR INVENTION

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, encoder and image encoding apparatus may be used with the same meaning and may be used interchangeably.

Hereinafter, decoder and image decoding apparatus may be used with the same meaning and may be used interchangeably.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

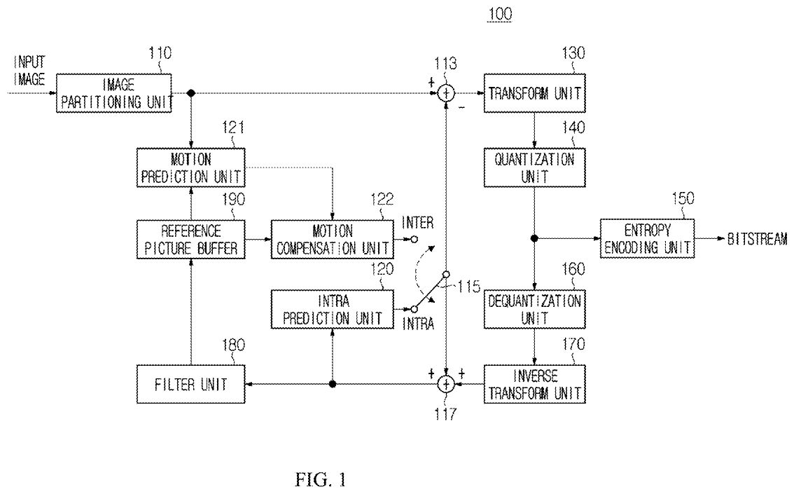

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units).

Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

Among these, the AFFINE mode is a technology that is used in both AMVP and MERGE modes and also has high encoding efficiency. In in the existing video coding standard, since MC (Motion Compensation) is performed by considering only the parallel movement of blocks, it has a disadvantage in that it cannot properly compensate for motions that occur in reality, such as zoom-in/out and rotation. To supplement this, a four-parameter affine motion model using two control point motion vectors (CPMVs) and a six-parameter affine motion model using three control point motion vectors may be used and applied to inter prediction. Here, CPMV is a vector representing the affine motion model of one of the upper left, upper right, and lower left of the current block.

The subtractor 113 may generate a residual block by using a difference between an input block and a prediction block. The residual block may be called a residual signal.

The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through ROT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through ROT, a function similar to TU partition may be performed through the sub-block Transform (SBT) technique. Specifically, SBT is applied only to inter prediction blocks, and unlike ROT, the current block may be partitioned into ½ or ¼ sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (LOW Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block r a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUS), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

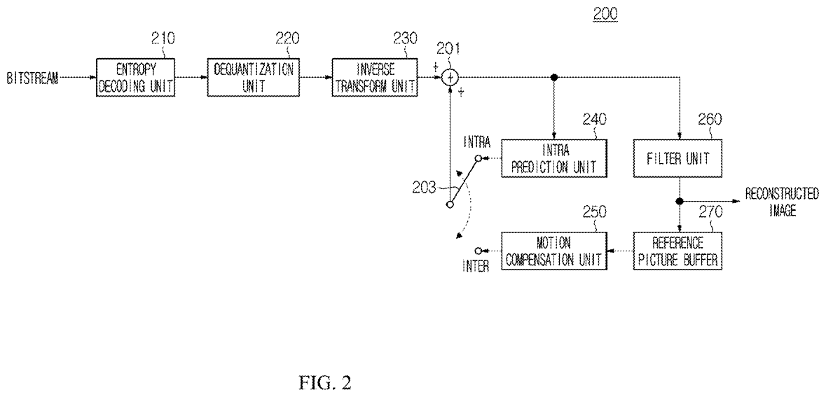

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

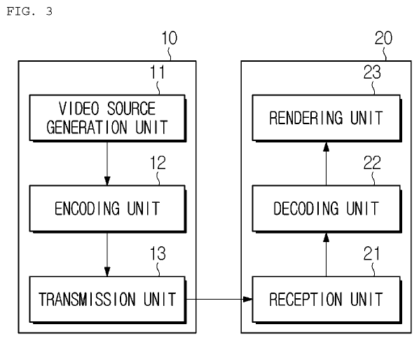

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12.

The reception unit 21 may be included in the decoding unit 22. The rendering unit 23 may include a display unit, and the display unit may be configured as a separate device or an external component.

The video source generation unit 11 may obtain the video/image through a process of capturing, synthesizing or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

An intra block copy (IBC)-based prediction method means a method of searching for an optimal prediction block in a reconstructed area of a current picture using a block vector and copying the optimal prediction block to generatea prediction block of a current block.

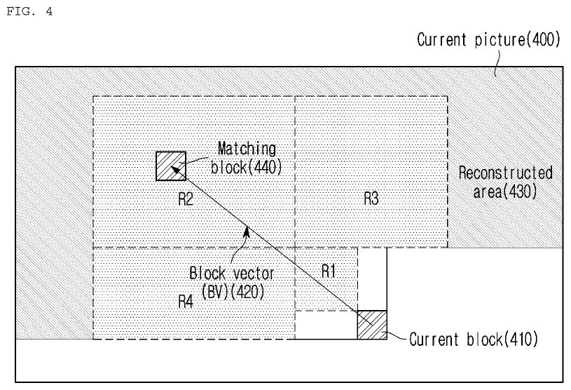

Hereinafter, with reference to FIGS. 4 to 7, an intra block copy-based prediction method according to an embodiment of the present invention will be described.

FIG. 4 is a diagram for explaining an intra block copy-based prediction method according to an embodiment of the present invention.

Referring to FIG. 4, a matching block 440 may be searched within predefined search ranges R1, R2, R3 and R4 of a reconstructed area 430 of a current picture 400 based on a block vector 420 of a current block 410. In addition, a prediction block of the current block 410 may be derived based on the matching block 440. Accordingly, when an intra block copy-based prediction method is applied to the current block 410, an encoder may transmit information about the intra block copy-based prediction method and information related to the block vector 420 to a decoder.

The predefined search ranges R1, R2, R3, and R4 in FIG. 4 may be defined as a current CTU (Coding Tree Unit) including the current block 410, a top left CTU located at the top left of the current CTU among the areas within the pre-set range from the current CTU, a top CTU located at the top of the current CTU among the areas within the pre-set range from the current CTU, and a left CTU located at the left of the current CTU among the areas within the pre-set range from the current CTU, respectively. Here, the area within the pre-set range may be an area set as one of a current tile, slice, or picture.

The intra block copy-based prediction method described in FIG. 4 is a uni-predictive intra block copy (IBC) that generates a prediction value using one block vector 420. On the other hand, according to another embodiment, the intra block copy-based prediction method may be a bi-predictive intra block copy (IBC) that uses two block vectors. The bi-predictive intra block copy-based prediction method may be as described below.

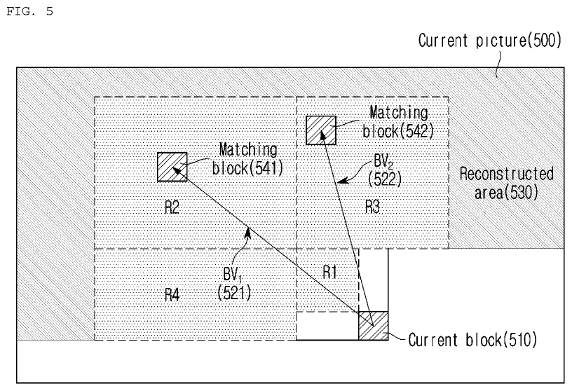

FIG. 5 is a diagram for explaining a bi-predictive intra block copy-based prediction method according to an embodiment of the present invention.

Referring to FIG. 5, a first matching block 541 and a second matching block 542 may be searched within predefined search range R1, R2, R3 and R4 of a reconstructed area 530 of a current picture 500 based on different block vectors of a current block 510, which are a first block vector BV₁ 521 and a second block vector BV₂ 522. In addition, a first prediction block of the current block 510 may be derived based on the first matching block 541, and a second prediction block may be derived based on the second matching block 542. In addition, a final prediction block for the current block 510 may be derived through a weighted sum of the first prediction block and the second prediction block. That is, the bi-predictive intra block copy-based prediction method may be a bi-predictive method using two block vectors 521 and 522.

The two block vectors 521 and 522 used in the bi-predictive intra block copy-based prediction method may be derived in various ways. According to one embodiment, the two block vectors 521 and 522 may be derived from an IBC block vector prediction (BVP) method and an IBC merge mode. In this case, an index for the IBC block vector prediction mode and an index for the IBC merge candidate may be signaled from the encoder to the decoder.

According to another embodiment, the two block vectors 521 and 522 may be derived from an IBC merge candidate list by utilizing different IBC merge indices. In this case, the merge indices indicating the two block vectors 521 and 522 may be signaled from the encoder to the decoder.

The bi-predictive intra block copy-based prediction method can improve coding efficiency compared to the uni-predictive intra block copy-based prediction method. However, if the prediction value is generated through a simple average of two prediction signals, prediction accuracy may be reduced.

In addition, according to one embodiment of the present invention, after two prediction blocks are generated based on two block vectors 521 and 522, a final prediction block may be generated by a weighted sum of the generated prediction blocks. The final prediction block may be generated according to Equation below.

$$P = {W}_{1} \times {P}_{BV 1} + {W}_{2} \times {P}_{BV 2} \qquad [ Equation 1 ]$$

where, P_{BV1} may mean a prediction value generated using a first block vector BV₁, and P_{BV2} may mean a prediction value generated from a second block vector BV₂. In addition, W₁ may mean a weight value applied to P_{BV1}, and W₂ may mean a weight value applied to P_{BV2}.

According to one embodiment, the weight values W₁ and W₂ may be determined according to arbitrary values promised in the encoder and decoder. In this case, the weight values W₁ and W₂ may not be signaled separately. Here, the sum of the weight values W₁ and W₂ is 1, and each of the weight values W₁ and W₂ is a real number greater than or equal to 0.

According to another embodiment, the weight values W₁ and W₂ may be transmitted to indicate one weight candidate among N preset weight candidates, and may be determined based on an index to be parsed. Here, N is an arbitrary positive integer. Here, the index may indicate the weight value W₁ applied to P_{BV1} and the weight value W₂ applied to P_{BV2}. The sum of the weight values W₁ and W₂ is 1.

Candidates of weight values assigned to different prediction blocks and an index and codeword assigned to each of the candidates of weight values may be as described in the table below.

TABLE 1

| Index | codeword | W₁ | W₂ |
|---|---|---|---|
| 0 | 0 | ¾ | ¼ |
| 1 | 10 | 2/4 | 2/4 |
| 2 | 11 | ¼ | ¾ |

Table 1 shows an embodiment of an index and a codeword assigned to each of the candidates of the weight value. However, the embodiment of Table 1 is only an embodiment of the present disclosure, and the number N of the weight value candidates (N≥2 is an integer), the codeword for the weight value candidates, and the weight value for each of the weight value candidates may be arbitrarily determined. In addition, a codeword for transmitting and/or parsing the index corresponding to the weight value candidates may be generated using one of any codeword assignment methods including a fixed length code (FLC), a unary code, a truncated unary code, and a truncated binary code.

In generating the codeword for weight value candidates, if the codeword is generated using VLC (variable length code) based on the occurrence probability of weight value candidates instead of FLC, the order of index assignment for weight value candidates may change. That is, as shown in the table below, short codewords may be assigned to weight values which are frequently occurred.

TABLE 2

| Index | codeword | W₁ | W₂ |
|---|---|---|---|
| 0 | 0 | ¾ | ¼ |
| 1 | 10 | 2/4 | 2/4 |
| 2 | 11 | ¼ | ¾ |

cvbnAccording to another embodiment, the weight values W₁ and W₂ may be determined based on K predefined categories and different weight value candidates W₁ and W₂ included in each of the categories. For each picture group/slice group/block group, an index indicating a category used among the K categories may be transmitted and parsed. In addition, for each lower level (e.g., picture, slice, block, QP unit), an index indicating a weight value used among a set of weight values included in the category may be transmitted and parsed.

According to another embodiment, the weight values W₁ and W₂ may use the distortion of each prediction value. A bi-predictive intra block copy prediction method based on the distortion of each prediction value may be as described below.

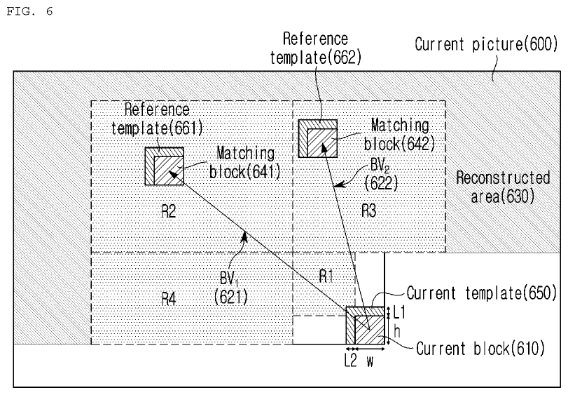

FIG. 6 is a diagram for explaining a bi-predictive intra block copy-based prediction method according to another embodiment of the present invention.

Referring to FIG. 6, a first matching block 641, which is the most similar block to a current block 610, may be searched within predefined search ranges R1, R2, R3 and R4 of a reconstructed area 630 of a current picture 600. A block vector indicating a first matching block 641 may be referred to as a first block vector BV₁ 621. In addition, a second matching block 642, which is the second most similar block to the current block 610, may be searched within predefined search ranges R1, R2, R3 and R4 of the reconstructed area. A block vector indicating the second matching block 642 may be referred to as a second block vector BV₂ 622.

In addition, the first prediction block of the current block 610 may be derived based on the first matching block 641, and the second prediction block may be derived based on the second matching block 642. In addition, a final prediction block for the current block 610 may be derived through a weighted sum of the first prediction block and the second prediction block.

The distortion of each of the first prediction block and the second prediction block derived based on the intra block copy may be determined based on a difference between a current template 650 adjacent to the current block 610 and reference templates 661 and 662 adjacent to matching blocks indicated by each of the block vectors 621 and 622.

The distortion value of the prediction signal derived based on the first block vector 621 may mean the distortion value between the current template 650 adjacent to the current block 610 and the first reference template 661, which is a reference template adjacent to the first matching block 641.

The distortion value of the prediction signal derived based on the second block vector 622 may mean the distortion value between the current template 650 adjacent to the current block 610 and the second reference template 662, which is a reference template adjacent to the second matching block 642.

The weight value applied to the prediction values obtained as a result of the intra block copy may be calculated based on the distortion value of the prediction signal derived based on the first block vector 621 and the distortion value of the prediction signal derived based on the second block vector 622, according to the equation below.

$${W}_{1} = \frac{{D}_{B V 2}}{{D}_{B V 1} + {D}_{B V 2}} , {W}_{2} = \frac{{D}_{B V 1}}{{D}_{B V 1} + {D}_{B V 2}} \qquad [ Equation 2 ]$$

where, D_{BV1} may mean a distortion value of a prediction signal derived based on the first block vector 621, and D_{BV2} may mean a distortion value of a prediction signal derived based on the second block vector 622. The weight value W₁ of the prediction signal derived based on the first block vector 621 may be calculated using D_{BV2}, and the weight value W₂ of the prediction signal derived based on the second block vector 622 may be calculated using D_{BV1}.

The smaller the distortion value, the greater the similarity between the prediction signal and the original signal, and conversely, the larger the distortion value, the less the similarity between the prediction signal and the original signal. Accordingly, the weight value of each signal may be calculated using the distortion values of different signals. The distortion of each signal may be calculated using various correlation measurement methods such as SAD (sum of absolute differences), SSE (sum of square error), MSE (mean squared error), SSD (sum of squared differences), and SATD (sum of absolute transformed differences).

In order to reduce the implementation and computational complexity of Equation 2, all floating-point operations may be changed to integer operations using a look-up table (LUT). That is, instead of floating-point operations, the approximate values of the weight values W₁ and W₂ may be derived using only integer multiplication, addition, and shift operations. For example, the weight values may be derived using the LUT of the Cross-Component Linear Model (CCLM).

According to another embodiment, if the distortion value of the prediction signal derived based on the first block vector 621 and the distortion value of the prediction signal derived based on the second block vector 622 are similar, it may not be meaningful to generate the prediction signal using the weighted sum. Therefore, the bi-predictive intra block copy-based prediction method may not be applied. Here, the distortion of each prediction signal may be calculated using various correlation measurement methods such as SAD, SSE, MSE, SSD, and SATD. The similarity of the distortion value may be derived according to the equation below.

$${D}_{min} \leq {Threshold}_{1} \qquad [ Equation 3 ]$$

where, Dₘᵢₙ may mean a smaller value among the distortion value of the prediction signal derived based on the first block vector 621 and the distortion value of the prediction signal derived based on the second block vector 622. In addition, Threshold means a threshold value. Accordingly, if the smaller distortion value among the distortion values of the two prediction signals is less than or equal to the threshold value, the two prediction signals may be determined to be similar. Here, the threshold value may be derived according to the equation below.

$${Threshold}_{1} = a \times {D}_{max} \qquad [ Equation 4 ]$$

Dₘₐₓ may mean a larger value among the distortion value of the prediction signal derived based on the first block vector 621 and the distortion value of the prediction signal derived based on the second block vector 622. In addition, x may mean an arbitrary positive real number. However, method for determining the similarity based on Equations 3 and 4 is only an example of determining the similarity between prediction signals, and the method for determining the similarity is not limited to the present embodiment.

According to another embodiment, if a difference between the distortion value of the prediction signal derived based on the first block vector 621 and the distortion value of the prediction signal derived based on the second block vector 622 is large, it may not be meaningful to generate the prediction signal using the weighted sum. Therefore, the bi-predictive intra block copy-based prediction method may not be applied. Here, the distortion of each prediction signal may be calculated using various correlation measurement methods such as SAD, SSE, MSE, SSD, and SATD. The dissimilarity of the distortion value may be derived according to the equation below.

$${D}_{max} \geq {Threshold}_{2} \qquad [ Equation 5 ]$$

Here, Dₘₐₓ may mean a larger value among the distortion value of the prediction signal derived based on the first block vector 621 and the distortion value of the prediction signal derived based on the second block vector 622. In addition, Threshold₂ means a threshold value. Accordingly, if the larger distortion value among the distortion values of the two prediction signals is greater than the threshold value, the two prediction signals may be determined to be not similar. Here, the threshold value may be derived according to the equation below.

$${Threshold}_{2} = β \times {D}_{min} \qquad [ Equation 6 ]$$

Dₘᵢₙ may mean a smaller value among the distortion value of the prediction signal derived based on the first block vector 621 and the distortion value of the prediction signal derived based on the second block vector 622. In addition, β may mean an arbitrary positive real number. However, method for determining dissimilarity based on Equations 5 and 6 is only an example of determining dissimilarity between prediction signals, and the method for determining dissimilarity is not limited to the present embodiment.

As illustrated in FIG. 6, in deriving distortion of prediction values, the L-shaped current template 650 around the current block 610 and the L-shaped reference templates 661 and 662 around each of the matching blocks 641 and 642 may be utilized.

On the other hand, according to another embodiment of the present invention, a template having a shape other than an L-shape may be used. That is, a distortion value for a matching block may be derived using a current template having a shape other than an L-shape and reference templates having a shape other than an L-shape. That is, when deriving distortion for prediction values, the distortion value for the prediction values may be derived by considering a plurality of template shape candidates rather than one template shape.

The plurality of template shape candidates used in the process of deriving distortion values for predicted values may be as described below.

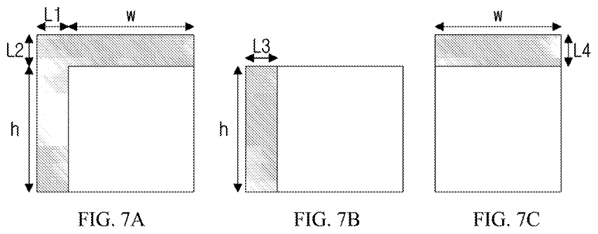

FIG. 7 is a diagram for explaining a plurality of template shape candidates used in a process of deriving distortion values for prediction values according to an embodiment of the present invention.

Referring to FIG. 7, for each of different prediction blocks derived from the bi-predictive intra block copy-based prediction results, a template having one shape among multiple template shape candidates having different shapes may be used.

Here, the template shape candidate may include neighboring samples on the left and top of the block, as in (a) of FIG. 7. The template shape candidate including neighboring samples on the left and top of the block may be referred to as an L-shaped template. The size of the L-shaped template may be expressed as (w×L2)+ (L1×h)+ (L1×L2). Here, w and h represent the width and height of the block, and the values of L1 and L2 may be any positive numbers.

Alternatively, the template shape candidate may include a neighboring sample on the left side of the block, as in (b) of FIG. 7. A template shape candidate including a neighboring sample on the left side of the block may be referred to as a left template. The size of the left template may be represented as L3×h. Here, h represents the height of the block, and the value of L3 may be any positive number.

Alternatively, the template shape candidate may include a neighboring sample on the top of the block, as in (c) of FIG. 7. The template shape candidate including the neighboring sample on the top of the block may be referred to as a top template. The size of the top template may be represented as w×L4. Here, w represents the width of the block, and the value of L4 may be any positive number.

According to the embodiment of FIG. 7, a distortion value for each of the matching blocks may be derived using a current template having one of the L-shaped template, the left template, and the top template and adjacent to the current block and reference templates having the same shape as the current template and adjacent to the matching blocks.

However, in addition to the example illustrated in FIG. 7, samples adjacent to block with various shapes predefined in the encoder and decoder may be used. The shape of the template is not limited to that described in the present invention.

Alternatively, the template used to derive distortion for the prediction values may be a template of a shape determined implicitly among an L-shaped template based on information such as the size and position of the current block, a template of FIG. 7, and various shapes of templates using samples adjacent to the block, which are predefined in the encoder and decoder

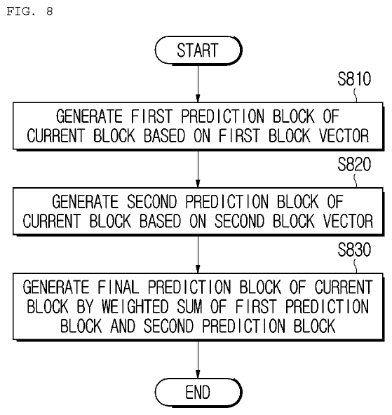

FIG. 8 is a flowchart illustrating an intra block copy prediction method according to an embodiment of the present invention.

The image decoding method of FIG. 8 may be performed by an image decoding apparatus.

The image decoding apparatus may generate a first prediction block of a current block based on a first block vector (S810). Specifically, the first prediction block may be generated based on a first matching block in a current picture indicated by the first block vector.

The image decoding apparatus may generate a second prediction block of the current block based on a second block vector (S820). Specifically, the second prediction block may be generated based on a second matching block in the current picture indicated by the second block vector.

The image decoding apparatus may generate a final prediction block of the current block by a weighted sum of the first prediction block and the second prediction block (S830).

Here, the first block vector may be derived by performing block vector prediction, and the second block vector may be determined based on an intra block copy merge candidate list and an index indicating one merge candidate.

Alternatively, the first block vector and the second block vector may be determined based on the intra block copy merge candidate list, and the first merge index and the second merge index indicating different merge candidates.

Here, the final prediction block of the current block may be generated by adding the first prediction block to which the first weight is applied and the second prediction block to which the second weight is applied.

Here, the first weight and the second weight may be determined as preset values.

Here, the first weight and the second weight may be determined based on an index indicating one weight candidate among a plurality of preset weight candidates.

Specifically, the first weight and the second weight may be determined based on a first index indicating one weight candidate set among a plurality of weight candidate sets and a second index indicating one weight candidate among a plurality of weight candidates included in the one weight candidate set.

Here, the first index may indicate a set of weight candidates used in at least one group among a picture group, a slice group, and a block group, and the second index may indicate a weight candidate used in at least one unit of a picture, a slice, and a block.

Here, at least one unit may be characterized as being a unit of a lower layer corresponding to at least one group.

Here, the first weight may be determined based on a first distortion value, which is a distortion value between a current template adjacent to the current block and a first reference template adjacent to the first matching block, and a second distortion value, which is a distortion value between a current template adjacent to the current block and a second reference template adjacent to the second matching block.

Here, the first distortion value and the second distortion value may be measured by any one of the following measurement methods: sum of absolute differences (SAD), sum of square error (SSE), mean squared error (MSE), sum of squared differences (SSD), and sum of absolute transformed differences (SATD).

Here, the first weight and the second weight may be determined based on a look-up table corresponding to the first distortion value and the second distortion value.

Here, the shape of the current template may be determined to be one of a first template shape including samples adjacent to the left side of the current block, a second template shape including samples adjacent to the top side of the current block, and a third template shape including samples adjacent to the left side of the current block and samples adjacent to the top side of the current block.

In addition, the shape of the first reference template and the second reference template may correspond to the shape of the current template.

Here, the final prediction block of the current block may be generated by a weighted sum of the first prediction block and the second prediction block, based on the comparison result between the threshold value, which is derived based on the first distortion value, and the second distortion value.

Here, the second distortion value is a value smaller than the first distortion value, and if the second distortion value is smaller than or equal to the threshold value, the final prediction block of the current block may be generated by a weighted sum of the first prediction block and the second prediction block.

Here, the second distortion value is a value larger than the first distortion value, and if the second distortion value is less than the threshold value, the final prediction block of the current block may be generated by a weighted sum of the first prediction block and the second prediction block.

Meanwhile, the steps described in FIG. 8 may be performed in an image decoding method and an image encoding method. In addition, a bitstream may be generated by an image encoding method including the steps described in FIG. 8. The bitstream may be stored in a non-transitory computer-readable recording medium, and may also be transmitted (or streamed).

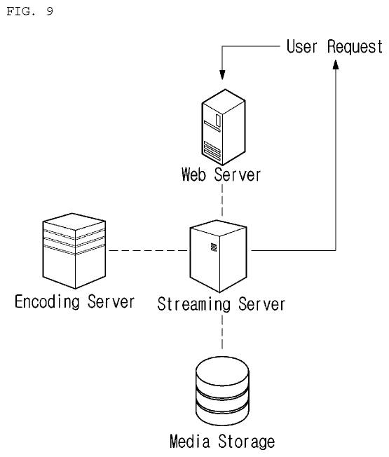

FIG. 9 is a view for illustrating a content streaming system to which an embodiment according to the present invention is applicable.

As illustrated in FIG. 9, a content streaming system to which an embodiment of the present invention is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present invention is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from a media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in an apparatus for encoding/decoding an image and a recording medium for storing a bitstream.

1. An image decoding method comprising:
generating a first prediction block of a current block based on a first block vector;
generating a second prediction block of the current block based on a second block vector; and
generating a final prediction block of the current block by a weighted sum of the first prediction block and the second prediction block,
wherein the first prediction block is generated based on a first matching block in a current picture indicated by the first block vector, and
wherein the second prediction block is generated based on a second matching block in the current picture indicated by the second block vector.

2. The image decoding method of claim 1,
wherein the first block vector is derived by performing block vector prediction, and
wherein the second block vector is determined based on an intra block copy merge candidate list and an index indicating one merge candidate.

3. The image decoding method of claim 1, wherein the first block vector and the second block vector are determined based on an intra block copy merge candidate list and a first merge index and second merge index indicating different merge candidates.

4. The image decoding method of claim 1, wherein the final prediction block of the current block is generated by adding the first prediction block to which a first weight is applied and the second prediction block to which a second weight is applied.

5. The image decoding method of claim 4, wherein the first weight and the second weight are determined to be preset values.

6. The image decoding method of claim 4, wherein the first weight and the second weight are determined based on an index indicating one weight candidate among a plurality of preset weight candidates.

7. The image decoding method of claim 6, wherein a codeword assigned to each of the plurality of preset weight candidates is determined based on a usage frequency of each of the plurality of weight candidates.

8. The image decoding method of claim 6, wherein the first weight and the second weight are determined based on a first index indicating one weight candidate set among a plurality of weight candidate sets and a second index indicating one weight candidate among a plurality of weight candidates included in the one weight candidate set.

9. The image decoding method of claim 8,
wherein the first index indicates a weight candidate set used in at least one of a picture group, a slice group or a block group, and
wherein the second index indicates a weight candidate used in at least one unit of a picture, a slice or a block.

10. The image decoding method of claim 9, wherein the at least one unit is a unit of a lower layer corresponding to the at least one group.

11. The image decoding method of claim 6, wherein the first weight and the second weight are determined based on a first distortion value, which is a distortion value between a current template adjacent to the current block and a first reference template adjacent to the first matching block, and a second distortion value, which is a distortion value between a current template adjacent to the current block and a second reference template adjacent to the second matching block.

12. The image decoding method of claim 11, wherein the first distortion value and the second distortion value are measured through any one of a sum of absolute differences (SAD) measurement method or a sum of square error (SSE) measurement method.

13. The image decoding method of claim 11, wherein the first weight and the second weight are determined based on a look-up table corresponding to the first distortion value and the second distortion value.

14. The image decoding method of claim 11,
wherein a shape of the current template is determined to be one of a first template shape including samples adjacent to the left side of the current block, a second template shape including samples adjacent to the top side of the current block, and a third template shape including samples adjacent to the left side of the current block and samples adjacent to the top side of the current block, and
wherein the shapes of the first reference template and the second reference template correspond to the shape of the current template.

15. The image decoding method of claim 11, wherein the final prediction block of the current block is generated by a weighted sum of the first prediction block and the second prediction block based on a comparison result between a threshold value, which is derived based on the first distortion value, and the second distortion value.

16. The image decoding method of claim 15,
wherein the second distortion value is a value smaller than the first distortion value, and
wherein based on the second distortion value is smaller than or equal to the threshold, the final prediction block of the current block is generated by a weighted sum of the first prediction block and the second prediction block.

17. The image decoding method of claim 15,
wherein the second distortion value is a value greater than the first distortion value, and
wherein based on the second distortion value is less than the threshold value, the final prediction block of the current block is generated by a weighted sum of the first prediction block and the second prediction block.

18. An image encoding method comprising:
generating a first prediction block of a current block based on a first block vector;
generating a second prediction block of the current block based on a second block vector; and
generating a final prediction block of the current block by a weighted sum of the first prediction block and the second prediction block,
wherein the first prediction block is generated based on a first matching block in a current picture indicated by the first block vector, and
wherein the second prediction block is generated based on a second matching block in the current picture indicated by the second block vector.

19. (canceled)

20. A method of transmitting a bitstream generated by an image encoding method, the transmission method comprising:
transmitting the bitstream,
wherein the image encoding method comprises:
generating a first prediction block of a current block based on a first block vector;
generating a second prediction block of the current block based on a second block vector; and
generating a final prediction block of the current block by a weighted sum of the first prediction block and the second prediction block,
wherein the first prediction block is generated based on a first matching block in a current picture indicated by the first block vector, and
wherein the second prediction block is generated based on a second matching block in the current picture indicated by the second block vector.
